(19) United States
(12) Patent Application Publication
(10) Pub. No.: US 2007/0155363 A1
(43) Pub. Date: Jul. 5, 2007

(54) Method and apparatus for providing a subscription lock for a wireless communication device

(76) Inventors: Kent D. Rager, Gurnee, IL (US); Bruce W. Brda, Barrington, IL (US); Philip Gilchrist, Inverness, IL (US)

Correspondence Address: MOTOROLA INC, 600 NORTH US HIGHWAY 45, ROOM AS437, LIBERTYVILLE, IL, 60048-5343, US

(21) Appl. No.: 11/324,069

(22) Filed: Dec. 30, 2005

(51) Int. Cl. H04M 3/16

(52) U.S. Cl. 455/410; 455/558

(57) ABSTRACT

A method and system for restricting at least partial usage of a wireless communication device 300, like a mobile telephone, includes a comparison of identification information 308 read from a user configuration module 307 with one or more restricted access identification codes. Where there is a match, some or all usage of the wireless communication 300 device is restricted. A usage restriction module 309 then compares the identification information 308 with one or more restricted access identification codes, which identify one or more networks associated with service providers with which usage of the wireless communication device is restricted. Where there is a match, at least partial use of the wireless communication device 300 is restricted.

### BACKGROUND

1. Technical Field

This invention relates generally to wireless communication devices that are responsive to configuration modules that identify a user or service provider, and more particularly to a method and apparatus for restricting at least partial usage of a wireless communication device when the configuration module matches at least one predetermined criterion.

2. Background Art

Wireless devices, like mobile telephones, pagers, and personal digital assistants for example, are growing in popularity around the world. Once sold in only technologically advanced countries, it is now not uncommon to find cellular phones and infrastructure in remote areas where landline phone service is not even available. Some countries even prefer to install wireless communication systems over conventional systems so as to avoid having to provide expensive copper wiring to every user. A single cellular telephone tower eliminates the need for many miles of copper wire.

While the global proliferation of wireless communication devices provides the people of the world with the ability to communicate with friends, family, coworkers and others, it presents unique challenges for manufacturers of the electronic devices themselves. When a manufacturer based in one country manufacturers the device in a second country and ships the device to a third country for sale, pricing becomes a complicated issue. Many variables affect the price at which a device is sold, including government regulation, tariffs, regulatory compliance costs, proximity to shipping centers and ports, shipping and fuel costs, fluctuating exchange rates, and subsidies that may be offered by service providers to retain loyal customers. Consequently, the very same device may sell at very different prices in different parts of the world.

Such price differentials provide the opportunity for arbitrage for those who may try to avoid sending product through proper channels. For example, a party may purchase devices in one country and ship them to another country without reporting the devices to the proper authorities, thereby avoiding applicable taxes. The party may then sell the devices in the destination country at prices below market, thereby undercutting the manufacturer's price. Such “grey market” activity prevents the manufacturer from equitably recouping its manufacturing and transaction costs in that market.

There is thus a need for a method and system for a service provider to restrict usage of hardware intended for use in one market from unauthorized use or grey market sale in other markets.

### BRIEF DESCRIPTION OF THE DRAWINGS

FIG. 1 illustrates one embodiment of a method for restricting usage of a wireless communication device in accordance with the invention.

FIG. 2 illustrates an alternate embodiment of a method for restricting at least partial usage of a wireless communication device in accordance with the invention.

FIG. 3 illustrates a block diagram of a wireless communication device in accordance with one embodiment of the invention.

FIG. 4 illustrates an alternate embodiment of a method for controlling access to a wireless communication device in accordance with the invention.

FIG. 5 illustrates a method for controlling access to a wireless communication device in accordance with the invention with an additional, secondary check included.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method and system for restricting at least partial usage of a wireless communication device. Components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of restricting at least partial usage of a wireless communication device as described herein. The non-processor circuits may include, but are not limited to, a radio receiver, a radio transmitter, signal drivers, clock circuits, power source circuits, and user input devices. As such, these functions may be interpreted as steps of a method to restrict partial usage of the wireless communication device. Alternatively, some or all functions could be implemented by a state machine that has no stored program instructions, or in one or more application specific integrated circuits (ASICs), in which each function or some combinations of certain of the functions are implemented as custom logic. Of course, a combination of the two (or more) approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

A system and method for restricting usage of a wireless communication device, like a subsidized mobile telephone for example, is provided. The wireless communication device is responsive to a user configuration module having identification information stored therein. The user configuration module, which may be a card, electronic key, or other device, identifies elements such as the user, billing information, service provider, and other information concerning the operation of the wireless communication device.

The wireless communication device includes a usage restriction module. The usage restriction module includes one or more restricted access identification codes. When the user configuration module is coupled to the wireless communication device, the wireless communication device reads identification information from the user configuration module. The usage restriction module, or a comparator coupled thereto, then compares at least a portion of the identification information with one or more of the restricted access identification codes. Where the identification information matches one or more of the restricted access identification codes, the usage restriction module restricts at least partial usage of the wireless communication device.

This embodiment prevents hardware, which may be offered, sold, or subsidized in one market, from being transferred to other markets without authorization, thereby enabling manufacturers or service providers the opportunity to equitably recover the costs incurred with lawfully bringing a product to market. Said differently, the usage restriction module restricts usage of the wireless communication device with predetermined, unauthorized user configuration modules and associated networks to prevent the purchase of a wireless communication device in one region and resale in another region for use with a predetermined set of restricted service providers. In so doing, the wireless communication device is capable of operating without restriction with user configuration modules of a certain type, while discouraging unauthorized use with user configuration modules of another type. In addition to service providers, manufacturers of hardware may desire such a usage restriction module where the same phone model is sold globally at different price points, as the module ensures that hardware is not purchased in one region and resold without authorization in another region.

The usage restriction module, as used in this document, should not be confused with a “subsidy lock” or “SIM lock” as those terms are commonly used in the art. Subsidy locks must determine a match between hardware and a user configuration module to permit registration with a network. The usage restriction module, by contrast, detects a match between identification information and restricted access identification codes to restrict at least partial usage of the device. The usage restriction module may be used in conjunction with, or without, a subsidy lock as an application warrants.

To illustrate by way of example, in one embodiment, the method is operable with a Global System for Mobile Communications (GSM) network. In a GSM network, a Subscriber Identification Module (SIM) card may be implemented as a part of the user configuration module. The SIM card identifies a user and a service provider when the GSM device determines whether to accept the SIM card and whether to attempt registration with a network.

Prior to registering with the network, the GSM device reads an International Mobile Subscriber Identification (IMSI) from the SIM card. In one embodiment, the GSM device then extracts a Home Public Land Mobile Network (HPLMN) identifier from the international mobile subscriber identification. The GSM device then compares the home public land mobile network identifier with one or more restricted Public Land Mobile Network (PLMN) identifiers stored within the GSM device. Where the home public land mobile network identifier does not match one or more of the restricted public land mobile network identifiers, indicative of the GSM device being in use with a user configuration module associated with a service provider that is not a precluded or restricted service provider, perhaps associated with an authorized region, the user is able to fully use the GSM device. Where the home public land mobile network identifier matches one of the restricted public land mobile network identifiers, the usage restriction module prevents at least partial use of the device, for example preventing the GSM device from registering with one or more networks. Such a match may occur where the user configuration module is issued by a service provider not expressly authorized, perhaps in an unauthorized region or grey market.

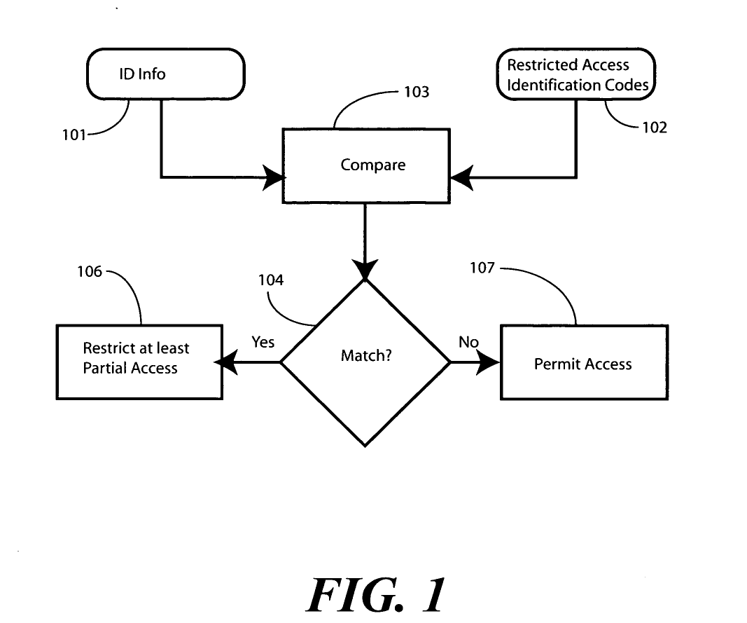

Turning now to FIG. 1, illustrated therein is one embodiment of a method for restricting usage of a wireless communication device. As noted above, the wireless communication device is responsive to a user configuration module having identification information 101 capable of identifying at least a user and a service provider stored therein. One example of such a user configuration module is a SIM card used in conjunction with GSM systems.

The wireless communication device includes a usage restriction module. The usage restriction module includes one or more restricted access identification codes 102. The one or more restricted access identification codes 102, in one embodiment, identify one or more networks or service providers whose user configuration modules are not authorized to operate with the wireless communication device. Said differently, the one or more restricted access identification codes 102 may identify one or more networks associated with service providers with which usage of user configuration modules in conjunction with the wireless communication device is restricted (for example, the one or more restricted access identification codes for all known service providers in a restricted market or region). A wireless communication device having a user configuration module issued by an non-restricted network or service provider would be able to register with one or more networks, while a wireless communication device having a user configuration module issued by an unauthorized network or service provider would have at least partial usage of the wireless communication device restricted. This restriction may include the inability to access any network for data or voice communication.

By way of example, where the wireless communication device is sold in one market or region, the device may be authorized to work with service provider A's user configuration module and corresponding network (which is located in that market or region), as well as the networks of other service providers B and C, with which service provider A has negotiated operating agreements. Where the user configuration module includes identification information identifying service provider A, the device will be operable and will be capable of registering with either service provider A's network or others with which service provider A has roaming agreements.

Where the user configuration module includes identification information matching one or more restricted access identification codes, at least partial usage of the device will be restricted. Such may be the case where the device has been resold into a market or region where only operators D, E, and F operate. User configuration modules provided by any of operators D, E, and F would constitute unauthorized user configuration modules. In such a scenario, the restricted access identification codes would include codes associated with operators D, E, and F. In these instances, at least partial usage of the device would be restricted when the identification information read from the user configuration modules identifies that the user configuration module is issued by any of these unauthorized operators.

At step 103 of the method, at least a portion of the identification information 101 is compared with the one or more restricted access codes 102. Where there is a match between the at least a portion of the identification information 101 and at least one of the one or more restricted access identification codes 102, as indicated at decision 104, the usage restriction module restricts at least partial usage of the wireless communication device at step 106. In one embodiment, the restriction of partial use includes disabling the wireless communication capabilities of the device. In another embodiment, the step of restricting partial usage of the device includes restricting usage other than emergency usage of the device. In other words, where there is a match between the at least a portion of the identification information 101 and at least one of the one or more restricted access identification codes 102, the device may still be available for making emergency calls to the appropriate authorities, for example calls to “911” systems that are available in many cities. The device may not, however, be available for making general-purpose calls that are not of emergency nature.

In another embodiment, the step of restricting partial usage of the wireless communication device includes preventing the device from registering with a network. In such an embodiment, local applications within the device, such as games, calculators, and address books may be available, but the device would not be able to exchange data with a network. Continuing the example from above, where the wireless communication device is sold in a market for use with service provider A, the device may be prevented from registering with any network when used with a user configuration module issued by operator D. Such may be the case where the wireless communication device is resold in a grey market region, without the authorization of service provider A.

Examples of networks suitable for operation in conjunction with the method include GSM networks, CDMA networks, TDMA networks, IDEN networks, WiMAX networks and UMTS networks. One skilled in the art having the benefit of this disclosure will readily appreciate that the teaching of this invention could be readily applied to other types of communication environments including most, if not all, types of communication networks. Other networks capable of exchanging voice and other data, including various types of wireless local area networks, will also be suitable for use with the methods and systems described herein.

As noted above, where the network is a GSM network, the user configuration module from which the identification information 101 is read may be a SIM card. The SIM card generally includes an international mobile subscriber identification having various information represented therein. In at least one embodiment, the international mobile subscriber identification includes a home public land mobile network. The home public land mobile network may then serve as the at least a portion of the identification information used in comparison step 103. Where the one or more restricted access codes 102 include one or more public land mobile networks, the step of comparing at least a portion of the identification information, i.e. a portion of the international mobile subscriber identification, with the one or more restricted access identification codes 102 comprises comparing the home public land mobile network with one or more public land mobile networks. Where a match has been identified between the identification information 101 and the restricted access identification codes 102 (decision 104), some or all of the usage of the wireless communication device is restricted (step 106).

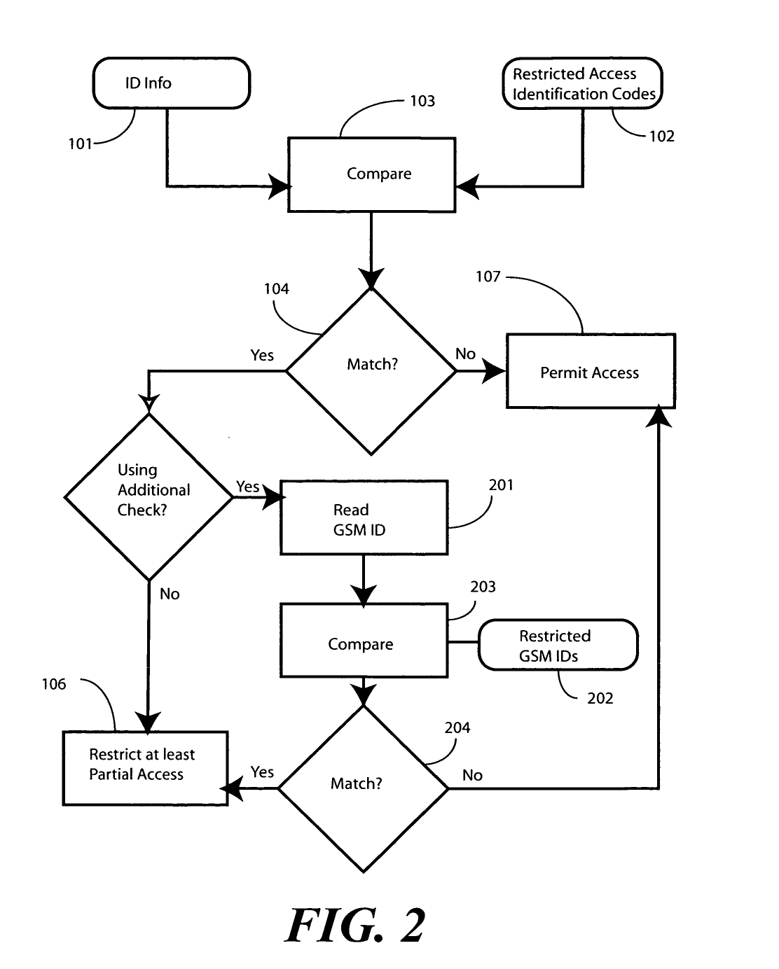

Turning now to FIG. 2, illustrated therein is an alternate embodiment of a method for restricting at least partial usage of a wireless communication device in accordance with the invention. The method of FIG. 2 is similar to the method of FIG. 1. However, the method of FIG. 2 includes an additional, second check prior to the restriction of at least partial usage that may be optionally included as warranted by the particular application.

In addition to the steps of comparing 103 at least a portion of the identification information 101 and one or more restricted access codes 102 and determining whether a match exists 104, a secondary comparison is provided. Such a secondary comparison is suitable for some networks, one example of which is a GSM network.

At step 201, the usage restriction module reads additional information from the user configuration module. In one embodiment, this additional information includes a GSM identification code that is stored within the user configuration module. Examples of these GSM identification codes include Group Identifier 1 (GID1) and Group Identifier 2 (GID2) information. At step 203, this GSM identification code is compared to one or more restricted GSM identification codes 202. The step of restricting at least partial usage 106 occurs when both the identification information, which may be a home public land mobile network in the GSM environment, matches any one of the restricted access identification codes, which may be public land mobile networks in the GSM environment, and the GSM identification code matches any one of the one or more restricted GSM identification codes 202 as determined at decision 204.

While the methods of FIGS. 1 and 2 may be operable at any time, in some embodiments, it is desirable to have the method execute when the wireless communication device is actuated. As user configuration modules are commonly inserted when the wireless communication devices are in their “off” state, a new network registration is required upon powering up. In such embodiments, the step of comparing the identification information 101 with the one or more restricted access identification codes 102 would occur when the device is activated. In so doing, where a user inadvertently inserted the wrong user configuration module, the user would be able to power down the wireless communication device, insert another user configuration module, and again activate the device. The wireless communication device may indicate to the user that a match between the identification information 101 and the one or more restricted access identification codes 102 has occurred by presenting an error message on a display, emitting an audible alarm, powering down the device, or otherwise enunciating an indication of alarm.

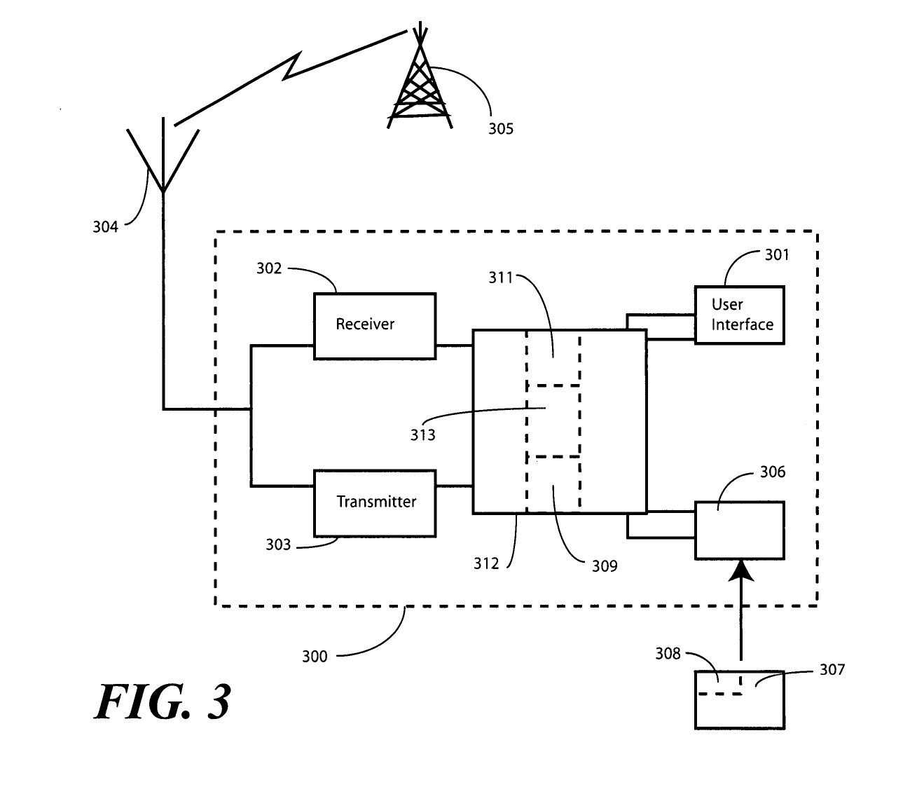

Turning now to FIG. 3, illustrated therein is a block diagram of a wireless communication device 300 in accordance with one embodiment of the invention. The wireless communication device 300 may include standard components like a user interface 301, which may include a display and a keypad or voice control system. Additionally, the device 300 includes wireless communication circuitry having at least one of a receiver 302 or a transmitter 303 and an antenna 304. Where the device 300 is a one-way communication device, either the receiver 302 or transmitter 303 will be present. Where the device 300 supports two-way communication, generally both the transmitter 302 and receiver 303, or a combined transceiver (implementing the receiver and transmitter together), will be present. Any of the receiver 302, transmitter 303 or transceiver will generally employ some form of the antenna 304 to wirelessly communicate with a base station transceiver 305 associated with a wireless communication network.

The device 300 includes a user configuration module reader 306 for receiving, or otherwise coupling to, and reading data from a user configuration module 307. The information stored within the user configuration module 307 may include identification information 308 suitable for identifying at least the service provider, user or both. In one embodiment, the identification information 308 includes information identifying at least the service provider with which the user or customer has a subscription for wireless communication services.

A control unit 312, which may be a microprocessor, a group of processing components, one or more Application Specific Integrated Circuits (ASICs), programmable logic or other processing device, includes a storage device 311, a comparator 313 and a usage restriction module 309. The storage device 311, comparator 313 and usage restriction module 309 may be integrated into the control unit 312, or may be independent components or software modules operating in concert with the control unit 312. Where employed as software modules, the usage restriction module 309, for example, may include one or more sets of prestored instructions for execution by the control unit 312 or another processor.

The storage device 311 stores one or more restricted access identification codes. These restricted access identification codes, as previously discussed in connection with FIGS. 1 and 2, identify at least a service provider or network or user configuration module associated with a service provider, for which usage of the wireless communication device is restricted. Thus, where user configuration modules issued by unauthorized service providers are coupled to the device 300, at least partial usage of the device 300, which may include the ability to register with a network, will be restricted.

A comparator 313 compares information, received from the user configuration module 307 by way of the user configuration module reader 306, with restricted access identification codes read from the storage device 311. Where there is a match, the subscription lockout module 309 restricts the wireless communication capabilities of the wireless communication device 300. This restriction may include impeding or disabling the receiver 302, the transmitter 303, or both.

Where the device 300 is a device suitable for operation within a GSM system, the user configuration module 307 may be a SIM card. In such a scenario, the identification information 308 may include a home public land mobile network, which may then be compared with one or more restricted public land mobile networks to determine whether access to the device 300 should be restricted.

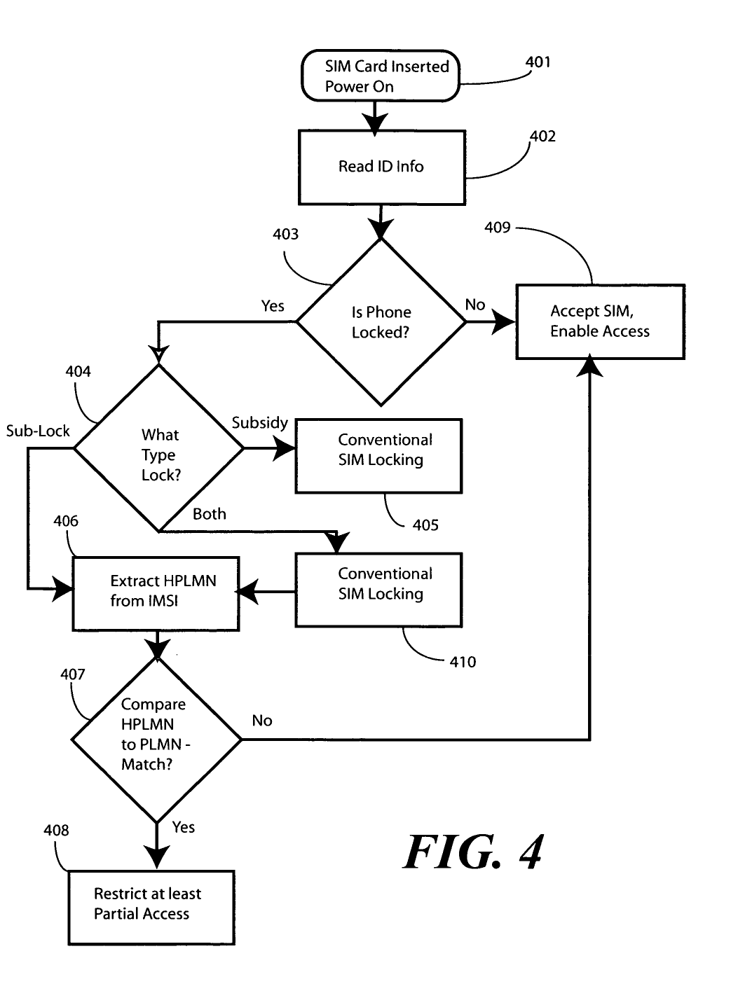

Turning now to FIG. 4, illustrated therein is an alternate embodiment of a method for controlling access to a wireless communication device. As noted above, one application suitable for the present invention is within hardware to preclude hardware that is purchased in one region from being resold for use in another region where usage is expressly restricted. Where a service provider or hardware manufacturer offers hardware in one region, restrictions against resale in other regions may be limited in duration. Certain restrictions associated with certain regions or markets may no longer be necessary or desirable after a certain period of time. For example, market forces, exchange rates, fuel costs, government action or other factors may change with time. Where this occurs, the restriction on usage of the device may be lifted. The method of FIG. 4 provides for limited time duration of locking restrictions. The method also illustrates how the present invention may be used in conjunction with a conventional subsidy lock.

At step 401, the device, which includes a usage restriction module, either receives a user configuration module or, in the alternative, has a user configuration module coupled thereto and is activated. The device reads identification information from the user configuration module at step 402.

At decision 403, the device checks to see whether a wireless communication device locking flag is set. Such may be the case where so long as restrictions upon usage of the device remain in place. The setting of this locking flag may be to indicate that either a conventional subsidy lock, or usage restriction module in accordance with the invention, should be employed. If the device is not locked, full access to the device is provided at step 409.

Where the locking flag is set, the device may check to see if the type of locking flag includes a requirement that user identification information be compared with one or more restricted access identification codes in accordance with the invention, or whether a conventional subsidy lock should be used. In other words, decision 404 determines whether the device should employ the subsidy lock or the usage restriction module. Where the subsidy lock is to be used, conventional subsidy locking methods may be practiced as is indicated by step 405. (Note that where both are used, the method proceeds through step 410.) Where the locking flag is set such that a method in accordance with the invention, i.e. the usage restriction module, is to be employed, at step 406 the device extracts at least a portion of the identification read at step 402. In the GSM embodiment, this step 406 includes extracting at least a home public land mobile network identifier from the identification information.

At decision 407, the portion of the identification information is compared to one or more restricted access identification codes. Again, using the GSM environment as an exemplary application, step 407 may include comparing a home public land mobile network identifier with one or more restricted public land mobile network identifiers. Where there is a match, a usage restriction module restricts at least partial usage of the wireless communication device. For example, where the home public land mobile network identifier matches any one of the one or more restricted public land mobile network identifiers, at least partial access to the device is restricted.

Note that as a restriction or limitation of the usage of the device may be only temporary in duration, the locking flag may also be temporary. Where a subsidy expires for example, a service provider may be able to transmit a locking flag PIN, or notify a user to enter a locking flag PIN, that deactivates the locking flag. As such, the step of restricting at least partial usage of the wireless communication device would continue only for as long as the locking flag remains set. Note also that the one or more restricted access identification codes may be dynamic in nature. For example, rather than being statically programmed in a factory, they may be dynamically downloadable. As such, in one embodiment, a step of downloading the plurality of prohibited public home mobile network identifiers prior to the step of comparing the home public land mobile network identifier with the one or more restricted public land mobile network identifiers may be included.

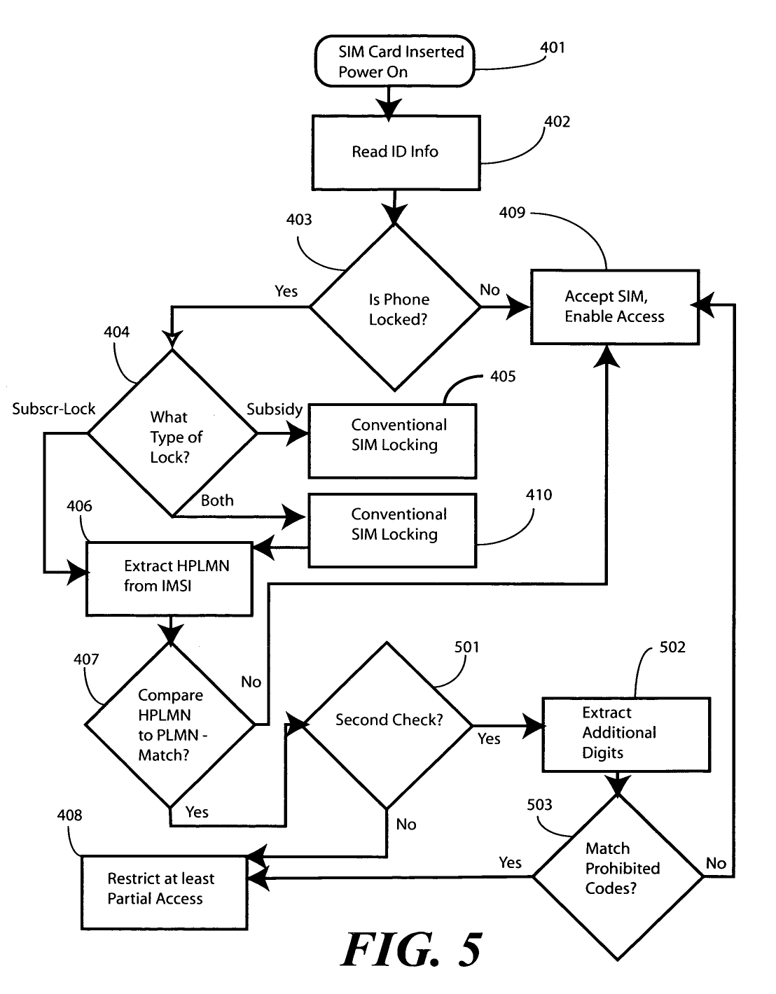

Turning now to FIG. 5, illustrated therein is the method of FIG. 4 with an additional, secondary check included. In the method of FIG. 5, where the identification information matches one or more restricted access identification codes, the device may perform an additional check prior to restricting at least partial usage of the wireless communication device.

By way of example, where such a secondary check is in place, as indicated at decision 501, the device extracts a one or more additional digits, in addition to the home public land mobile network, from the identification information, which may comprise an international mobile subscriber identification, at step 502. These one or more digits are then compared with one or more restricted digit codes at decision 503. Where both the home public land mobile network identifier equals any one of the one or more restricted public land mobile network identifiers and the one or more digits equals any one of the restricted digit codes, the usage restriction module restricts at least partial access to the wireless communication device.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method of restricting usage of a wireless communication device, where the wireless communication device is responsive to a user configuration module having identification information capable of identifying at least a user and a service provider therein, the wireless communication device comprising a usage restriction module including one or more restricted access identification codes, the method comprising the steps of:
a. comparing at least a portion of the identification information with the one or more restricted access identification codes; and
b. restricting at least partial usage of the wireless communication device where the at least a portion of the identification information matches at least one of the one or more restricted access identification codes.

2. The method of claim 1, wherein the step of restricting at least partial usage comprises disabling wireless communication capabilities of the wireless communication device.

3. The method of claim 2, wherein the step of restricting at least partial usage comprises restricting usage other than emergency usage of the wireless communication device.

4. The method of claim 1, wherein the step of restricting at least partial usage comprises preventing the wireless communication device from registering with a wireless communication system network.

5. The method of claim 4, wherein the network is selected from the group consisting of analog cellular networks, GSM networks, CDMA networks, TDMA networks, iDEN networks, WiMAX networks and UMTS networks.

6. The method of claim 1, wherein the one or more restricted access identification codes identify one or more networks associated with service providers with which usage of the wireless communication device is restricted.

7. The method of claim 1, wherein the user configuration module comprises a subscriber identification module, further wherein the identification information comprises an international mobile subscriber identification.

8. The method of claim 7, wherein the at least a portion of the international mobile subscriber identification comprises a home public land mobile network identifier, such that the step of comparing at least a portion of the international mobile subscriber identification with the one or more restricted access identification codes comprises comparing the home public land mobile network identifier with the one or more restricted access identification codes.

9. The method of claim 8, wherein the one or more restricted access identification codes comprise one or more restricted public land mobile network identifiers, such that the step of comparing the home public land mobile network identifier with the one or more restricted access identification codes comprises comparing the home public land mobile identifier with one or more restricted public land mobile network identifiers.

10. The method of claim 9, prior to the step of restricting at least partial usage of the wireless communication device, further comprising the steps of:
a. reading a GSM identification device code from the user configuration module;
b. comparing the GSM identification device code to one or more restricted GSM identification device codes; and
c. performing the step of restricting at least partial access to the wireless communication device where both the home public land mobile network identifier matches any one of the one or more restricted public land mobile network identifiers and the GSM identification device code matches any one of the one or more restricted GSM identification device codes.

11. The method of claim 1, wherein the step of comparing at least a portion of the identification information with the one or more restricted access identification codes occurs when the electronic device is activated.

12. A usage restriction module comprising:
a. a storage device for storing one or more restricted access identification codes, where the one or more restricted access identification codes identify at least a service provider with which usage of a wireless communication service is restricted;
b. a comparator for comparing information received from a user configuration module to the one or more restricted access identification codes; and
c. a lockout module capable of restricting wireless communication capabilities of a wireless communication device where the comparator detects a match.

13. The module of claim 12, wherein the information received from a user configuration module comprises information identifying at least a service provider with which a user has a subscription for access to wireless communication services.

14. The module of claim 13, wherein the user configuration module comprises a subscriber identification module card, further wherein the information received from the subscriber identification module card comprises at least a home public land mobile network identifier.

15. The module of claim 13, wherein the module is disposed within and operable with a wireless communication device having an antenna and at least one of a receiver and a transmitter associated therewith.

16. The module of claim 13, wherein the module includes one or more sets of prestored instructions for execution by a processor.

17. A method of controlling access to a wireless communication device, the method comprising the steps of:
a. reading an identification information from user configuration module;
b. determining whether a wireless communication device locking flag is set;
c. where the wireless communication device locking flag is set, extracting at least a home public land mobile network identifier from the identification information;
d. comparing the home public land mobile network identifier with one or more restricted public land mobile network identifiers; and
e. restricting at least partial usage of the wireless communication device where the home public land mobile network identifier matches any one of the one or more restricted public land mobile network identifiers.

18. The method of claim 17, where the locking flag is temporary, where the step of restricting at least partial usage of the wireless communication device continues only for as long as the locking flag remains set.

19. The method of claim 17, prior to the step of restricting at least partial usage of the wireless communication device, further comprising the steps of:
a. extracting a plurality of digits from the international mobile subscriber identification;
b. comparing plurality of digits with one or more restricted digit codes; and
c. performing the step of restricting at least partial access to the wireless communication device where both the home public land mobile network identifier equals any one of the one or more restricted public land mobile network identifiers and the plurality of digits equals any one of the restricted digit codes.

20. The method of claim 16, further comprising the step of downloading the plurality of prohibited public home mobile network identifiers prior to the step of comparing the home public land mobile network identifier with the one or more restricted public land mobile network identifiers.
